(19) United States
(12) Patent Application Publication
(10) Pub. No.: US 2022/0416689 A1
(43) Pub. Date: Dec. 29, 2022

(54) METHOD OF USING A HYDROELECTRIC ACTUATOR TO CREATE A CONTROLLABLE PRESSURE ON A CYLINDRICALLY SHAPED OBJECT

(71) Applicant: ElastiMed Ltd., Yokneam Ilit (IL)

(72) Inventors: Vered Shuster Ben Yosef, Tel Aviv (IL); Omer Zelka, Tel Aviv (IL)

(21) Appl. No.: 17/770,825

(22) PCT Filed: Oct. 21, 2020
(86) PCT No.: PCT/IB2020/000877

§ 371 Date: Apr. 21, 2022

Related U.S. Application Data
(60) Provisional application No. 62/923,697, filed on Oct. 21, 2019.

(51) Int. Cl. H02N 1/00; A61H 9/00

(52) U.S. Cl. CPC H02N 1/002; A61H 9/0021; A61H 9/0007; A61H 2209/00; A61H 2201/165; F04B 9/10

(57) ABSTRACT

The embodiments in this disclosure are directed towards, for example, a hydro-electric actuator which pushes a contained dielectric liquid by applying an electrostatic force. The dielectric liquid is within at least one closed chamber in some embodiments. The disclosure includes a method of making at least one closed chamber using at least one dielectric film. In some embodiments, the at least one dielectric film is coated with electrodes from opposite sides.

### FIELD

In some embodiments, the present disclosure relates to a soft actuator, which creates a controllable pressure on a cylindrically shaped object by harnessing electrostatic and hydraulic forces.

### BACKGROUND

To create controllable pressure on cylindrically shaped objects, such as a human or animal limb, pneumatic actuators may be used.

Electro-active polymer (EAP) based actuators have been introduced recently in this domain, harnessing electrostatic forces on soft materials (e.g., dielectric elastomers) to create controllable pressure. These actuators may function as elastic capacitors, such that when voltage is applied, the Maxwell stress causes the electrodes to squeeze the dielectric elastomer between them, which in turn, causes the dielectric elastomer to expand. These actuators can be challenging to produce however, as dielectric elastomers, may be difficult to work with.

### SUMMARY

Covered embodiments are defined by the claims, not this summary. This summary is a high-level overview of various aspects and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

In some embodiments, the present disclosure is directed to a hydro-electric actuator which pushes a contained dielectric liquid, by applying an electrostatic force. In some embodiments, the dielectric liquid is within at least one closed chamber. In some embodiments, the present disclosure is directed to a method of making at least one closed chamber using at least one dielectric film. In some embodiments, the at least one dielectric film is coated with electrodes from opposite sides.

In some embodiments, a first electrode is connected to a positive charge and a second electrode is connected to a negative charge. In some embodiments, when the first and second electrodes are charged by a voltage, the first and second electrodes are mechanically attracted to each other, by the Maxwell stress tensor, thereby reducing the available space for a X fluid in the at least one closed chamber. In some embodiments, reducing the available space for the dielectric fluid in the at least one closed chamber causes the dielectric fluid to create an equal pressure on the edges of the at least one closed chamber, according to Pascal's law, thereby causing the at least one closed chamber to transform in shape. In some embodiments, the transformable closed chamber can be referred to as a soft actuator.

In some embodiments, wrapping the soft actuator around a cylindrically shaped object, such as a human or animal limb, and applying a voltage on the electrodes, will create a controllable pressure on the cylindrically shaped object. In some embodiments, the controllable pressure will correlate to the applied voltage. In some embodiments, increasing the applied voltage, increases the controllable pressure.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIGS. 1A, 1B and 1C schematically illustrates a hydro-electric actuator wrapped around a cylindrically shaped object, such as a human or animal limb, for example, but not limited to a leg, a calf, a hand or an arm according to some embodiments of the present disclosure.

FIGS. 2A, 2B and 2C schematically illustrates a sequence of actions of the hydro-electric actuator according some embodiments of the present disclosure.

FIGS. 3A, 3B, 3C and 3D are charts which generally illustrates an exemplary procedure of sequential and intermittent pressure applied by 4 EAP actuators.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Throughout the specification and claims, the following terms take the meanings explicitly associated herein, unless the context clearly dictates otherwise. The phrases “in one embodiment,” “in an embodiment,” and “In some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

All prior patents, publications, and test methods referenced herein are incorporated by reference in their entireties.

In some embodiments, the present disclosure is directed to a hydro-electric actuator. In some embodiments, which pushes a contained dielectric liquid, by applying an electrostatic force. In some embodiments, the dielectric liquid is contained within at least one closed chamber. In some embodiments, the at least one closed chamber is made of at least one dielectric film. In some embodiments, the at least one dielectric film is coated with electrodes from opposite sides. In some embodiments, one electrode is connected to a positive charge and the second electrode is connected to a negative charge. In some embodiments, the electrodes are charged by a voltage, and are mechanically attracted to each other, by Maxwell stress tensor, thereby reducing the available space for the dielectric liquid in the at least one closed chamber. In some embodiments, reducing the available space for the dielectric liquid in the at least one closed chamber, causes the dielectric liquid to create an equal pressure on the edges of the at least one closed chamber, according to Pascal's law (principle of transmission of fluid-pressure), causing the at least one closed chamber to transform in shape. In some embodiments, the at least one transformable closed chamber can be referred to as a soft actuator. In some embodiments, wrapping the soft actuator around a cylindrically shaped object, such as a human or animal limb, and applying a voltage on the electrodes, can create a controllable pressure on the cylindrically shaped object. In some embodiments, the controllable pressure will correlate to the applied voltage. In some embodiments, increasing the applied voltage, will in turn increase the applied pressure.

As used herein, a “conductor” refers to an object or type of material that allows the flow of electrical current in one or more directions. In some embodiments, the conductive material can be stretchable, extensible or inflexible.

Throughout this description the term “dielectric film” is used to indicate electrically insulating or poorly conductive film which can be polarized in the presence of electric field. The use of the term “dielectric film” is a general descriptive of a genus and should not be limited to any particular shape, construction material, geometry, or combination thereof, and at least some embodiments of the present disclosure cover are directed to all suitable dielectric materials, such as the Polymeric or non-polymeric dielectric material (including but not limited to: Polyimide, Polyethylene Polypropylene, and PTFE) Silicon and acrylic film or foam, any other similarly suitable material, or any combination thereof. In some embodiments, at least one dielectric film can be assembled as at least one multi-layered structures from different layers of dielectric materials. In some embodiments, at least one dielectric film layer may be made from a solderable material for example, but not limited to Polypropylene (e.g., BOPP by CosmoFilms). In some embodiments, at one of the at least one dielectric film layers can from with a high insulation capability for example, but not limited to Polyimide (e.g., Kapton by DuPont).

In some embodiments, the at least one dielectric film may include at least one “electro-active polymer” or “EAP.” The term “Electro-Active Polymer,” “electro-active polymer” or “EAP EAP” is used to indicate dielectric elastomer film(s) adapted to be stretched biaxially or in a single axis. The use of the term “EAP” is a general descriptive of a genus and should not be limited to any particular shape, construction material and/or geometry, and at least some embodiments of the present disclosure are directed to all suitable elastic materials, such as the 3M™ VHB™ 4910, 4905, 4955, 4959 or 9460 Tape, the Hi-Bond VST4050 Tape, Dow Corning™ or Nusil™ silicon elastomer, Elastosil or Silpuran film by Wacker, ePTFE or any other suitable silicon, acrylic, PTFE, rubber, parylene or polyacrylamide dielectric elastomer. Additional non-limiting examples of EAP materials are described in Patent Cooperation Treaty (PCT) Application No. US 2019/030212, filed on May 1, 2019.

Throughout this description the term “Dielectric liquid” is used to indicate an insulative or poorly conductive liquid which can be polarized in the presence of electric field. The use of the term “Dielectric liquid” is a general description of a genus and should not be limited to any particular shape, construction, material geometry, or combination thereof. At least some embodiments of the present disclosure cover are directed to all suitable dielectric liquids, such as transformer oil (for example, but not limited to, Mineral oil, Silicone oil, Fluorocarbon oil) transformer fluid (for example, but not limited to, Electrifill fluid), any water in oil emulsion or any aqueous solution containing organic compounds with large molecular structure as additives to water, such as ethylene glycol, glycerin.

Throughout this description the term “closed chamber” is used to indicate a deformable laminated thin-walled such as a shell. The use of the term “closed chamber” is a general description of a genus and should not be limited to any particular shape, construction material, geometry, and at least some embodiments of the present disclosure cover are directed to all suitable shapes, such as a stretchable, extensible or inflexible shell. In some embodiments, at least one closed chamber can be one continuous chamber, divided into sub-chambers, or any combination thereof.

In some embodiments, at least one closed chamber might be assembled by any method, for example but not limited to, lamination, heat sealing, vacuum sealing adhesion, any other similarly suitable method of attachment or any combination thereof.

In some embodiments, wrapping the soft actuator around solid body applies sufficient pressure to the solid body. In some embodiments activating the soft actuator increases the pressure which is applied on the solid body by sufficiently pressing on the at least one closed chamber. In some embodiments, deactivating the soft actuator, reduces the pressure which is applied on the solid body by relaxing the at least one closed chamber.

In some embodiments, the at least one dielectric film of the present disclosure can be used as a pressure device. In some embodiments, X number of Dielectric films can be wrapped around a solid body. In some embodiments, the solid body is a cylindrical body.

In some embodiments, X is between 1 and 10,000. In some embodiments, X number of Dielectric films can be wrapped around the solid body, wherein X is between 1 and 5,000. In some embodiments, X number of Dielectric films can be wrapped around the solid body, wherein X is between 1 and 1,000. In some embodiments, X number of Dielectric films can be wrapped around the solid body, wherein X is between 1 and 500. In some embodiments, X number of Dielectric films can be wrapped around the solid body, wherein X is between 1 and 100.

In some embodiments, X is between 2 and 10,000. In some embodiments, X number of Dielectric films can be wrapped around the solid body, wherein X is between 2 and 5,000. In some embodiments, X number of Dielectric films can be wrapped around the solid body, wherein X is between 2 and 1,000. In some embodiments, X number of Dielectric films can be wrapped around the solid body, wherein X is between 2 and 500. In some embodiments, X number of Dielectric films can be wrapped around the solid body, wherein X is between 2 and 100.

In some embodiments, X number of Dielectric films can be wrapped around the solid body, wherein X is between 100 and 10,000. In some embodiments, X number of Dielectric films can be wrapped around the solid body, wherein X is between 500 and 10,000. In some embodiments, X number of Dielectric films can be wrapped around the solid body, wherein X is between 1,000 and 10,000. In some embodiments, X number of Dielectric films can be wrapped around the solid body, wherein X is between 5,000 and 10,000.

In some embodiments, the at least one dielectric films can be wrapped in parallel along the solid body. In some embodiments, activating the at least one dielectric films simultaneously can be used to apply intermittent pressure. In some embodiments, activating the at least one dielectric films sequentially can be used to apply intermittent sequential pressure. In some embodiments, Y is the time required to raise or reduce the pressure applied by the at least one dielectric films, by deactivating or activating the at least one dielectric films, wherein Y is between 0.01 seconds and 100 seconds. In some embodiments, when applying intermittent pressure using the at least one dielectric film, the pressure is kept sufficient for amount of time, wherein X is between 0.1 seconds and 1 hour. In some embodiments, when applying intermittent pressure using the at least one dielectric film, the pressure is kept low (wherein “low” is at least one low pressure described herein for X amount of time, wherein X is between 1 seconds and 1 hour. In some embodiments, when applying sequential pressure using the at least one dielectric film, the pressure is kept high for X amount of time, wherein X is between 0.1 seconds and 0.5 hour. In some embodiments, when applying sequential pressure using the at least one dielectric film, the pressure is kept low for X amount of time, wherein X is between 0.5 seconds and 100 seconds. In some embodiments, when applying sequential pressure, the time difference between activating on Dielectric film and a different Dielectric film is X, wherein X is between 1 seconds and 100 seconds.

In some embodiments, while the film is applying high pressure, the pressure is between 6 mmHg and 1000 mmHg. In some embodiments, while the at least one dielectric film is applying low pressure, the pressure is between 5 mmHg and 999 mmHg.

In some embodiments, while the film is applying high pressure, the pressure is between 6 mmHg and 800 mmHg. In some embodiments, while the at least one dielectric film is applying low pressure, the pressure is between 5 mmHg and 799 mmHg.

In some embodiments, while the film is applying high pressure, the pressure is between 6 mmHg and 600 mmHg. In some embodiments, while the at least one dielectric film is applying low pressure, the pressure is between 5 mmHg and 599 mmHg

In some embodiments, while the film is applying high pressure, the pressure is between 6 mmHg and 400 mmHg. In some embodiments, while the at least one dielectric film is applying low pressure, the pressure is between 5 mmHg and 399 mmHg.

In some embodiments, while the film is applying high pressure, the pressure is between 6 mmHg and 200 mmHg. In some embodiments, while the at least one dielectric film is applying low pressure, the pressure is between 5 mmHg and 199 mmHg

In some embodiments, while the film is applying high pressure, the pressure is between 6 mmHg and 100 mmHg. In some embodiments, while the at least one dielectric film is applying low pressure, the pressure is between 5 mmHg and 99 mmHg

In some embodiments, a thickness of the at least one dielectric film is between 1 micron to 1 cm. In some embodiments, the thickness of the at least one dielectric film is from 10 microns to 1 cm. In some embodiments, the thickness of the at least one dielectric film is from 100 microns to 1 cm. In some embodiments, the thickness of the at least one dielectric film is from 1 micron to 1 cm. In some embodiments, the thickness of the at least one dielectric film is from 1 micron to 1 mm. In some embodiments, the thickness of the at least one dielectric film is from 10 microns to 1 millimeter. In some embodiments, the thickness of the at least one dielectric film is from 100 microns to 1 mm. In some embodiments, the thickness of the at least one dielectric film is from 10 microns to 100 microns.

In some embodiments, the at least one dielectric film is coated with a conductor. In some embodiments, the conductor might be at least one of the following, including but not limited to, carbon or silver based conducting ink, Polyaniline (PAni) based solution, carbon based solution, carbon black powder, conducting polymer, conductive rubber, conductive silver or carbon paste, conductive epoxy, conducting grease, laser cut or molded rigid conducting sheet in an expanding pattern, graphite powder based solution, stretchable conducting sheet comprising networks of gold or carbon, nano-particles embedded in elastic polyurethane, or any combination thereof. In some embodiments, the conductor might be attached to the at least one dielectric film by, for example but not limited to, printing, etching, brushing, water dispersion, gluing, a vacuum deposition process or spinning coating, or any other similarly suitable method of attachment or any combination thereof. In some embodiments, the stretchable conductor comprises carbon black powder. In some embodiments, the stretchable conductor comprises a conductive polymer. In some embodiments, the stretchable conductor is made from conductive rubber. In some embodiments, the expanding pattern is at least one of a zigzag pattern, an expanding diamond pattern, or any combination thereof. In some embodiments, an exemplary conductor is in a form of a semi-stiff conductor including, for example but not limited to, a conducting ink (e.g., silver and/or carbon-based conductive ink, for example Creative Materials, Inc. (Massachusetts, US) 125-10 silver based electrically conductive ink. In some embodiments, the exemplary conductor is in a form of a stretchable conductor, such as, for example, a stretchable electrical conductor that includes networks of gold nanoparticles, carbon nanoparticles, or any combination thereof, embedded in elastic polyurethane. In some embodiments, the exemplary conductor comprises a carbon black powder layer attached to the electro-active polymer, for example but not limited to, Ketjenblack EC-600JD powder by Akzo Nobel (Amsterdam, Netherlands), Super C 65 by C-Nergy or 250P by Ensaco (Timcal, Cleveland, Ohio). In some embodiments, the exemplary conductor comprises carbon or silver paste, for example but not limited to WIK20489-56A by Henkel (Dusseldorf, Germany). In some embodiments, the exemplary conductor comprises carbon or silver conductive epoxy, for example but not limited to H20E by Epo-Teck. In some embodiments, the exemplary conductor comprises Polyaniline (PAni) based solution, carbon-based solution, a laser cut or molded rigid conducting sheet, or any combination thereof. In some embodiments the conductor can be a conductive hydrogel. In some embodiments, the conductive hydrogen comprises a conductive polymer (CP) and a hydrogel.

In some embodiments, the conductor can be rigid and inflexible and may include materials such as, but not limited to, copper or aluminum, gold and silver, titanium, steel, Zinc, Nickel, cobalt, platinum. In some embodiments, the expanding pattern is one of a zigzag pattern, and expanding diamond pattern. In some embodiments, the conductor might be attached to the at least one dielectric film by methods including but not limited to, printing, etching, brushing, water dispersion, gluing, vacuum deposition process or spinning coating, any other similarly suitable method of attachment, or any combination thereof.

In some embodiments, the exemplary conductor utilized in accordance with the present disclosure is chosen from a stretchable conductor, a rigid conductor in an expanding pattern, a printed conductor in an expanding pattern, and any combination thereof.

In some embodiments, the exemplary conductor utilized in accordance with the present disclosure is selected from the group consisting of a stretchable conductor, a rigid conductor in an expanding pattern, a printed conductor in an expanding pattern, and any combination thereof.

In some embodiments, the exemplary stretchable conductor utilized in accordance with the present disclosure can comprise networks of gold nanoparticles, carbon nanoparticles, or any combination thereof embedded in elastic polyurethane, or any other suitable stretchable conductor.

In some embodiments, the exemplary stretchable conductor utilized in accordance with the present disclosure can be comprise a layer of carbon black powder glued to the electro-active polymer or any other suitable stretchable conductor.

In some embodiments, the exemplary stretchable conductor utilized in accordance with the present disclosure can comprise a conducting polymer or any other suitable stretchable conductor.

In some embodiments, the exemplary stretchable conductor utilized in accordance with the present disclosure can comprise a conducting rubber or any other suitable stretchable conductor.

In some embodiments, the exemplary stretchable conductor utilized in accordance with the present disclosure can include a carbon or silver paste or any other suitable stretchable conductor.

In some embodiments, the exemplary stretchable conductor utilized in accordance with the present disclosure can include a carbon or silver epoxy or any other suitable stretchable conductor.

In some embodiments, the exemplary stretchable conductor utilized in accordance with the present disclosure can be created by conductive hydrogels produced from a conductive polymer (CP) and a hydrogel or any other suitable stretchable conductor.

In some embodiments, the conductor can be rigid, and inflexible, and may include, for example but not limited to, copper or aluminum, gold and silver, titanium, steel, Zinc, Nickel, cobalt, platinum, or any combination thereof.

In some embodiments, the exemplary conductor utilized in accordance with the present disclosure can be created by at least one of: laser cutting a solid conductor, molding a solid conductor, etching a solid conductor, or any combination thereof. In some embodiments, an exemplary printed conductor utilized in accordance with the present disclosure can be a made with a conducting ink comprising at least one of silver, carbon, or any combination thereof.

Additional non-limiting examples of conductors are described in Patent Cooperation Treaty (PCT) Application No. US 2019/030212, filed on May 1, 2019.

In some embodiments, an exemplary expanding pattern utilized in accordance with the present disclosure includes at least one of a zigzag pattern, an expanding diamond pattern, any other suitable expanding pattern, or any combination thereof.

In some embodiments, the attachment of an exemplary conductor to at least one dielectric film is done by printing, etching, brushing, water dispersion, gluing, ion-attachment and/or any other suitable method of the attachment.

In some embodiments, each conducting layer is attached to the at least one dielectric film layer by, for example but not limited to, at least one of printing (e.g., utilizing conductive ink), etching (e.g., using a solution of electrolyte), brushing (e.g., using carbon graphite powder with silicon oil), water dispersion (e.g., using PAni based solution), gluing (e.g., gluing a laser cut or molded into an expanding pattern such as zigzag, rigid conducting sheet), any other suitable applicable method, or any combination thereof.

In some embodiments, the exemplary method of the present disclosure further includes using more than one layer and up to 1,000 layers of dielectric films, thereby improving at least one of strength, durability, or any combination thereof of the at least one dielectric film. In some embodiments, the exemplary method of the present disclosure further includes using more than one layer and up to 800 layers of dielectric film. In some embodiments, the exemplary method of the present disclosure further includes using more than one layer and up to 600 layers of dielectric film. In some embodiments, the exemplary method of the present disclosure further includes using more than one layer and up to 400 layers of dielectric film. In some embodiments, the exemplary method of the present disclosure further includes using more than one layer and up to 200 layers of dielectric film. In some embodiments, the exemplary method of the present disclosure further includes using more than one layer and up to 100 layers of dielectric films in order to improve strength and/or durability of the at least one dielectric film.

In some embodiments, the present disclosure includes at least one multi-layered structure of dielectric films. In some embodiments, the least one multi-layered structure of dielectric films is made by, for example but not limited to, folding a single film, attaching multiple films to each other, or any combination thereof.

In some embodiments, parameters may be altered to affect expansion and a direction of the expansion. Examples of such parameters include, but are not limited to: Electrode shape, size and area which effect on the active/inactive ratio; Actuator layers; an electrical charge being applied (e.g., from 10V-20,000V, from 100V-20,000V, from 1000V-20,000V, from 10V-1,000V, from 10V-10,000V, from 10,000V-20,000V); segmented pouches; at least one of a method of fixation attachment or a type of fixation attachment; or any combination thereof.

In some embodiments of the present disclosure, the methods described herein can be configured to apply static compression, sequential compression, segmental compression, intermittent compression, or any other type of compression. In some embodiments, the methods and apparatuses described herein can be used for the prevention and or treatment for various vascular or lymphatic diseases, for example, but not limited to, DVT (Deep Vein Thrombosis), lymphedema, varicose veins, spider veins, CVI (Chronic Venous Insufficiency), ulcers, superficial venous thrombosis or phlebitis and diabetic wounds. In some embodiments, the active compression bandage can be used for the prevention and/or treatment and/or reduction of, for example, but not limited to, scar tissue, swelling, sore muscles, burn wounds, cellulitis, chronic edema, eczema, infected wounds and epidermolysis bullosa. In some embodiments, the methods and apparatuses described herein can be used to reduce the recovery time of orthopedic surgeries, swelling, infections and sport injuries. In some embodiments, the recovery time can be reduced by 1 to 100%, from 2 to 50%, from 4 to 25%, from 8 to 12%; from 9 to 10% and all ranges therebetween.

In some embodiments, methods of the present disclosure may include steps of: wrapping the apparatus around a solid body and at least partially electrically activating the conductor layer to apply a first voltage, wherein the application of the first voltage to the solid body applies or reduces a first pressure to the solid body.

In some embodiments, the present disclosure provides a method for keeping an apparatus described herein a pre-stretched state/condition on a single axis, by wrapping and fixing it around a solid body, e.g. a human body part.

In some embodiments, an apparatus described herein is either ON or OFF (activated or deactivated). In some embodiments, the apparatus is partially activated. In some embodiments, pressure can be varied by a certain amount by changing the voltage, so that different treatment options can be applied for different patients.

In some embodiments, varying the voltage can keep a constant pressure on a solid body. For example, if a stiffness of the solid body is variable, (e.g. because the solid body is bent or straightened) the voltage can be varied to account for this change.

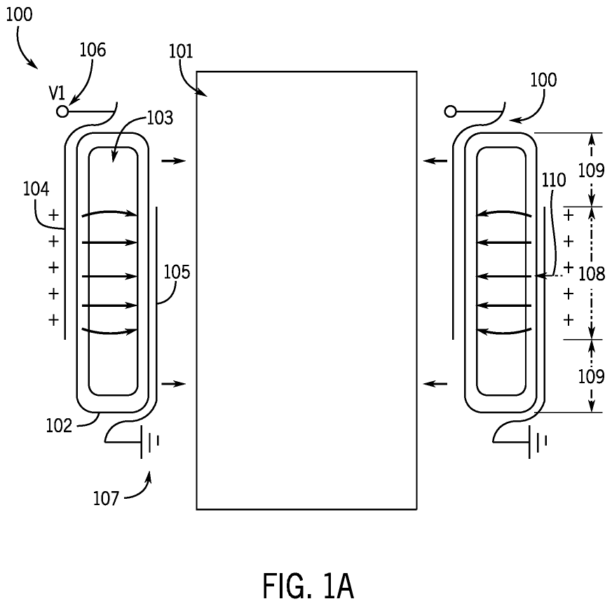

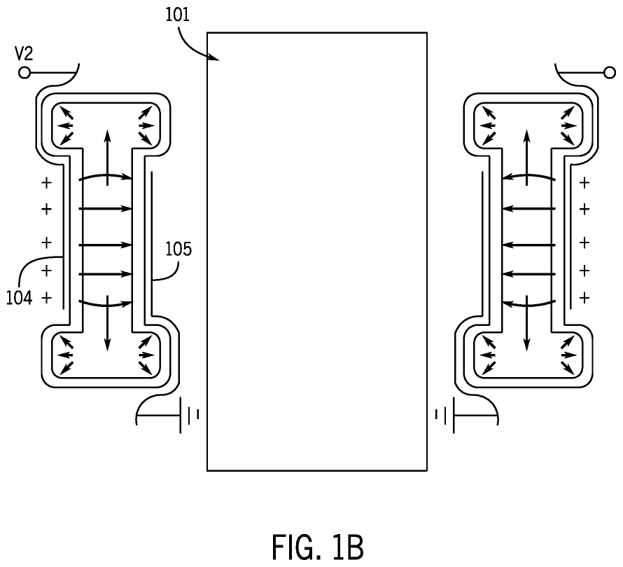

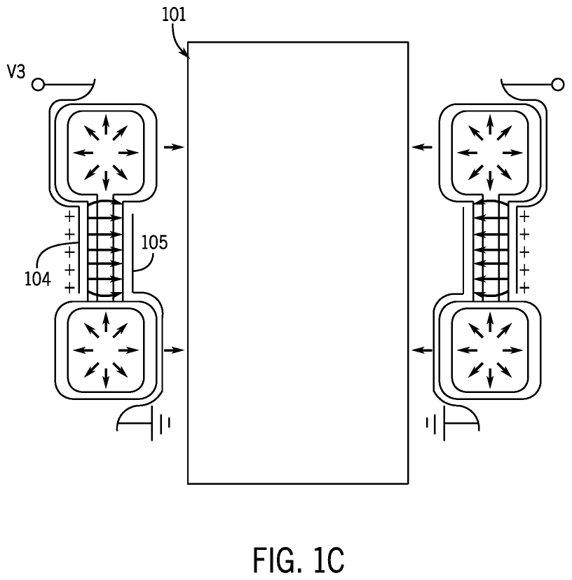

FIG. 1A, schematically illustrates a non-limiting example of a hydro-electric actuator (100) wrapped around cylindrical shape body (101), (for example, but not limited to a leg or calf, or hand or an arm), which includes a flexible closed chamber structure, comprising dielectric film (102), and a dielectric liquid (103) within the at least one closed chamber (102). The first electrode (104) may be created by attaching conductor over one side of the interior closed area (102), and the second electrode (105) may be created by attaching a conductor over the opposite side of the at least one closed chamber (102).

FIG. 1A illustrates an exemplary conductor configuration where the electrodes are attached to the outer surface of the laminated thin-walled structure (102). Conductor configurations of the present disclosure are not limited to this example. Other embodiments visualize that the two electrodes (104,105) could be attached above an inner surface of the at least one closed chamber structure. In some embodiments, one electrode could be attached above the inner surface of the at least one closed chamber structure (102) and the other can be attached to the outer surface of closed chamber structure (102). Notwithstanding whether the electrodes are attached (inside or outside of the at least one closed chamber, one of the electrodes are connected to a voltage 106 (DC or AC) source and the other to the ground 107.

The electrode configuration on the at least one closed chamber structure may create two areas: an active area (108) is where the electrodes are attached and an inactive area (109) is an area without any attached electrodes. The position of the active and inactive areas can be replaced, and one area can be surrounded by other. FIG. 1A illustrates that the active area (108) can be surrounded by the inactive side (109), but not limited to this example. In some embodiments, the inactive area can be surrounded by an active area. In any case, when voltage is applied across the electrodes (104 and 105), an electric field through the dielectric liquid (103) may be created, which may generate an electrostatic force along a reference axis (110) that attracts the electrodes.

FIG. 1B and FIG. 1C, schematically illustrate a conversion between electrical and mechanical energy by the hydro-electric actuator (100). The hydro-electric actuator is wrapped around cylinder shape body (101). When the voltage is applied, the generated electrostatic force, caused by the Maxwell stress tensor, attracts the electrodes on the active site (108) of the at least one closed chamber structure. The electrostatic force pushes the dielectric liquid (103) towards the inactive area and creates a fluidic pressure that acts on the at least one closed chamber walls, according to Pascal's law. This fluidic pressure can distort the at least one closed chamber in different directions. This deformation creates a mechanical force towards the cylinder shape body (102).

As illustrated in FIG. 1A, FIG. 1B and FIG. 1C the hydro-electric actuator may be deformed according to the voltage applied. As the voltage increases, the fluidic pressure increases the mechanical force toward the cylinder shape body due to the distortion of the at least one closed chamber (corresponding to the at least one closed chamber's elasticity)

The ratio of the active area and inactive area can be modified for scaling the fluidic pressure and the resulting mechanical force.

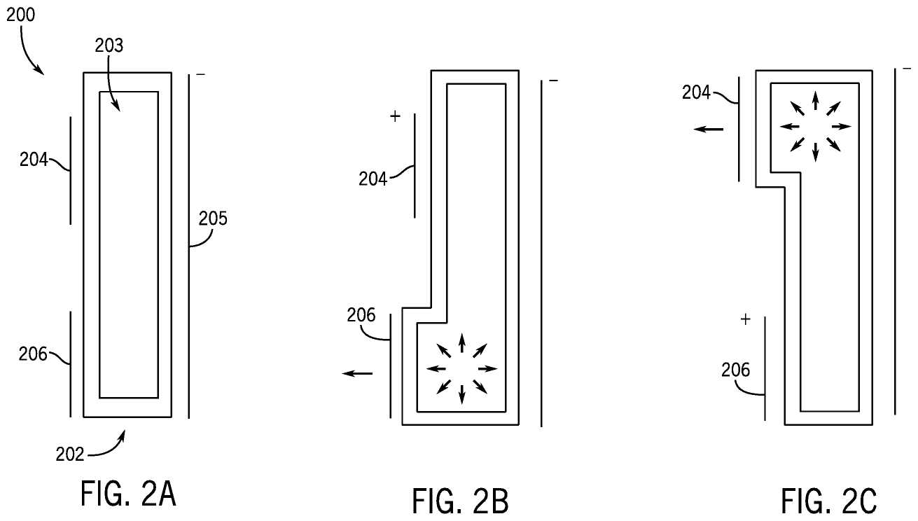

FIG. 2A schematically illustrates an example hydro-electric actuator (200), which according to some embodiments of the present disclosure, may include a number of different active and inactive areas. Similar to FIGS. 1A, 1B and 1C, the actuator may include a flexible closed chamber structure, including at least one dielectric film (202), and a dielectric liquid (203) contained within the at least one closed chamber (202). The first electrode (205) may be created by attaching a conductor over one side of the at least one closed chamber (202), which is connected a ground source. On an opposing side of the at least one closed chamber, at least two separate conductive surfaces, may create at least two separate electrodes (204 and 205). FIG. 2B, schematically illustrates a condition of applying a voltage on one at least electrode (204) of the at least two electrodes (204 and 205). The generated electrostatic force, which may be caused by the Maxwell stress tensor, attracts the electrodes (204 and 205) to close the at least one chamber structure. The electrostatic force pushes the dielectric liquid (203) towards the inactive electrode area (206) and creates a fluidic pressure that acts on the at least one closed chamber walls, according to Pascal's law. This fluidic pressure can distort the at least one closed chamber in different directions. FIG. 2C, schematically illustrates a condition of applying a voltage on one electrode (206). The generated electrostatic force, caused by the Maxwell stress tensor, attracts the electrodes (206 and 205) to close the at least one chamber structure. The electrostatic force pushes the dielectric liquid (203) towards the inactive electrode area (204) and creates a fluidic pressure that acts on the at least one closed chamber walls, according to Pascal's law. This fluidic pressure can distort the at least one closed chamber in different directions. This methodology when wrapping the actuator around a cylinder shape body allows for creating a sequential intermittent pressure.

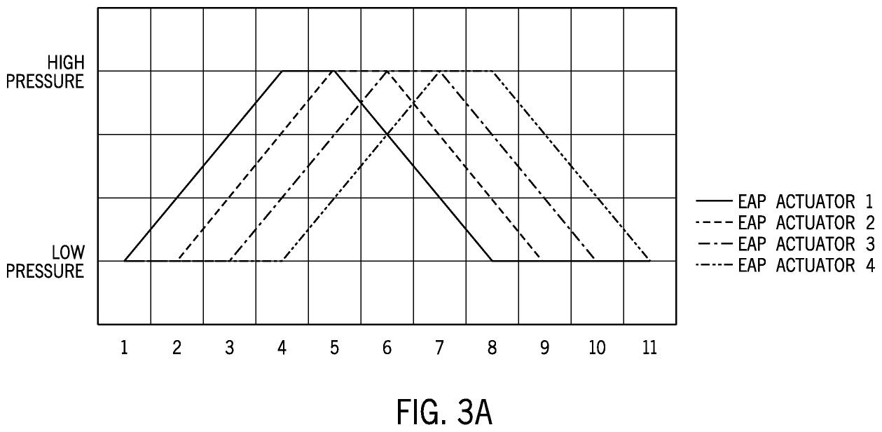

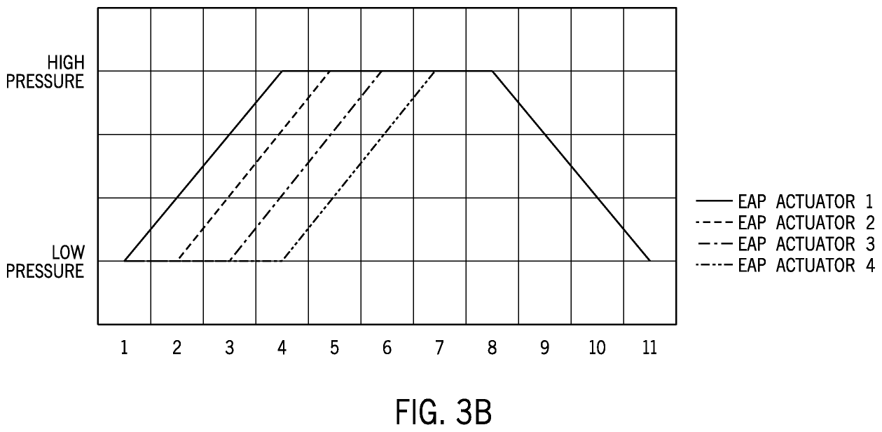

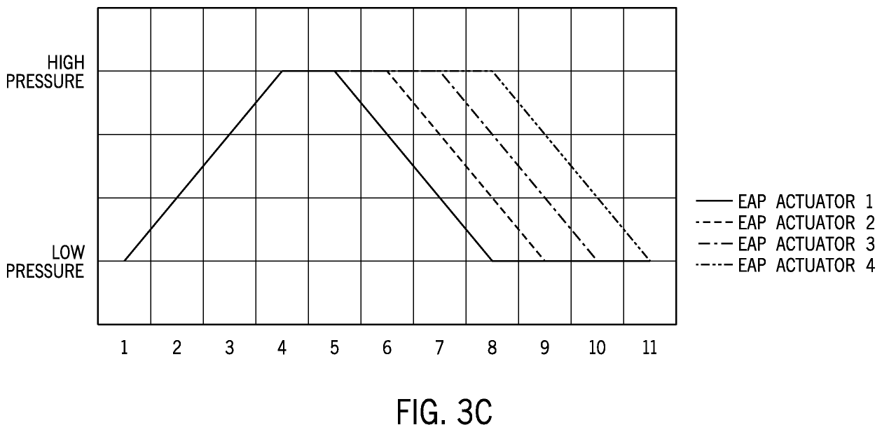

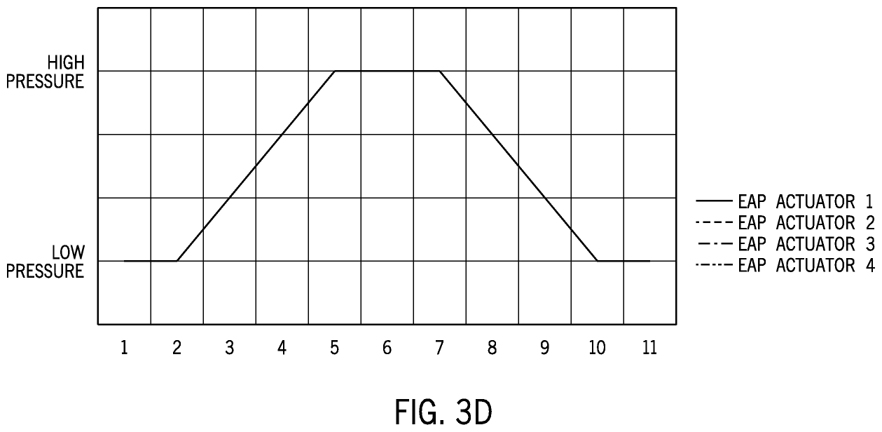

FIGS. 3A, 3B and 3C are charts which generally illustrate an exemplary procedure of applying sequential pressure applied by 4 hydroelectric actuators comprising at least one dielectric film in that includes an electro active polymer (hereinafter, “EAP actuators”). The 4 EAP actuators may be wrapped in parallel along the solid body and in which high pressure (i.e., any value for high pressure described herein) is being applied sequentially. FIG. 3D is a chart which generally illustrates an exemplary procedure of applying intermittent pressure applied by 4 EAP actuators, in which the 4 EAP actuators are wrapped in parallel along the solid body and the high pressure is being applied intermittently by the 4 EAP actuators at once.

At least one aspect of the present disclosure will now be described with reference to the following non-limiting numbered embodiments.

E1: A method comprising:

wrapping at least one hydro-electric actuator around a cylindrical body;
wherein the at least one hydro-electric actuator comprises:
a dielectric liquid;
at least one dielectric film,

wherein the at least one dielectric film forms at least one chamber,

wherein the at least one chamber comprises a plurality of walls,

wherein the dielectric liquid is within the at least one chamber,

a positive electrode,

wherein the positive electrode is disposed on a first side of the at least one dielectric film; and
a negative electrode,

wherein the negative electrode is disposed on a second side of the at least one dielectric film;

applying at least one pressure to the cylindrical body with the at least one hydroelectric actuator,
wherein applying the at least one pressure to the cylindrical body comprises:

applying at least one voltage to at least one of: the positive electrode, the negative electrode, or any combination thereof.

E2: The method of E1, where the at least one pressure is a sequence of pressures.

E3: The method of E1, E2, or any combination thereof, where the cylindrical body is chosen from at least one human body part, at least one animal body part, or any combination thereof, and where the method is a method of treating a human patient, an animal patient, or any combination thereof for at least one condition described herein (including but not limited to at least one condition set forth in paragraph [0056], at least one condition described in Patent Cooperation Treaty (PCT) Application No. US 2019/030212, filed on May 1, 2019, or any combination thereof).

Variations, modifications and alterations to embodiments of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present disclosure as defined in the claims.

The disclosure described herein may be practiced in the absence of any element or elements, limitation or limitations, which is not specifically disclosed herein. Thus, for example, in each instance herein, any of the terms “comprising,” “consisting essentially of and “consisting of” may be replaced with either of the other two terms. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1. A method comprising:
wrapping at least one hydro-electric actuator around a cylindrical body,
wherein the at least one hydro-electric actuator comprises:
a dielectric liquid;
at least one dielectric film,
wherein the at least one dielectric film forms at least one chamber, the at least one chamber comprises a plurality of walls, and the dielectric liquid is within the at least one chamber;
a positive electrode,
wherein the positive electrode is disposed on a first side of the at least one dielectric film; and
a negative electrode,
wherein the negative electrode is disposed on a second side of the at least one dielectric film; and
applying at least one pressure to the cylindrical body with the at least one hydroelectric actuator,
wherein applying the at least one pressure to the cylindrical body comprises:
applying at least one voltage to at least one of: the positive electrode, the negative electrode, or any combination thereof.

2. The method of claim 1, where the at least one pressure is a sequence of pressures.

3. The method of claim 1, wherein the cylindrical body is chosen from at least one body part.

4. The method of claim 1, wherein the method is for treating at least one or more condition(s) of:
Deep Vein Thrombosis, lymphedema, varicose veins, spider veins, Chronic Venous Insufficiency, ulcers, superficial venous thrombosis, phlebitis diabetic wounds, scar tissue, swelling, sore muscles, burn wounds, cellulitis, chronic edema, eczema, infected wounds, epidermolysis bullosa, and to reduce the recovery time of orthopedic surgeries, swelling, infections, and sport injuries.
